(19) United States
(12) Patent Application Publication
(10) Pub. No.: US 2017/0169690 A1
(43) Pub. Date: Jun. 15, 2017

(54) METHOD AND APPARATUS FOR GENERATING OUTPUT SIGNALS ON THE BASIS OF SENSORS PROVIDED IN AN OBJECT FOR SITTING OR LYING ON

(71) Applicant: Fraunhofer-Gesellschaft zur Foerderung der angewandten Forschung e.V., Munich (DE)

(72) Inventors: Norman PFEIFFER, Bamberg (DE); Bjoern SCHMITZ, Erlangen (DE); Erik HASSLMEYER, Nuernberg (DE); Daniel TANTINGER, Erlangen (DE); Sven FEILNER, Erlangen (DE); Andreas HUBER, Nuernberg (DE); Matthias STRUCK, Fuerth (DE); Christian HOFMANN, Nuernberg (DE)

(21) Appl. No.: 15/373,932

(22) Filed: Dec. 9, 2016

(30) Foreign Application Priority Data
Dec. 9, 2015 (EP) 15198778.1
Dec. 6, 2016 (EP) 16202433.5

(51) Int. Cl. G08B 21/04; B60N 2/02; B60N 2/00

(52) U.S. Cl. CPC G08B 21/0446; B60N 2/002; B60N 2/0244; B60N 2002/0268

(57) ABSTRACT

An apparatus includes an object for sitting or lying on, a plurality of sensors arranged within the object for sitting or lying on, and a signal processing unit connected to the sensors. The signal processing unit is provided to generate, on the basis of the sensor signals, an output signal which describes a posture and/or a movement of a person using the object for sitting or lying on. The generated output signal indicates a center of gravity of the person and/or a physiological process occurring in the person.

### CROSS-REFERENCE TO RELATED APPLICATIONS

This application claims priority from EP Patent Application No. 16202433.5, which was filed on Dec. 6, 2016, and from EP Patent Application No. 15198778.1, which was filed on Dec. 9, 2015, which are each incorporated herein in its entirety by this reference thereto.

The present invention generally relates to the field of sensor technology, in particular to the field of sensor technology provided in an object for sitting or lying on. Embodiments relate to an apparatus and a method for generating output signals on the basis of sensors signals of sensor arranged inside a seat or a bed and on the basis of which a person's posture and/or movement is determined.

### BACKGROUND OF THE INVENTION

Conventional technology knows of various approaches to generating output signals on the basis of sensors arranged inside an object for sitting or lying on.

DE 10 2013 215 095 A1 describes a method of avoiding impairment to the health of a vehicle occupant while utilizing vehicle dynamics. A seating surface of a seat on which a passenger is sitting has pressure sensors provided therein which determine if and with which intensity a passenger leans to the left or to the right when a vehicle is driving around bends. In addition, a display is provided for representing a virtual object whose position on the display is changed accordingly while the vehicle is driving around bends. As a function of the force exerted on one of the sensors by the passenger, a movement of the virtual element on the display is counteracted, so that the passenger is encouraged to move. This approach is disadvantageous since the generated control signal serves exclusively to counteract any movements of a virtual object without describing general utilization with different terminal devices, games or programs.

US 2011/0086747 A1 describes a chair which is connectable to a game console and with the aid of which a game is controlled via movements of the arm, the torso, the legs and the fingers of a user of the chair. The movements of corresponding elements of the chair come up against a resistance, so that the games also involve physical exercise on the part of the user. The disadvantage of this approach consists in that it involves utilization of additional mechanical elements.

U.S. Pat. No. 6,392,550 B1 describes a method and an apparatus for monitoring the alertness of the driver of a vehicle. To this end, several pressure sensors are arranged inside a vehicle seat and may be used for monitoring a driver's posture. As a function of a detected posture which indicates tiredness, an alert is output. The disadvantage of this approach consists in that a self-contained system is provided which merely results in a driver to be alarmed; control of further devices is not possible.

Moreover, publications in the field of age-appropriate assistance systems for a healthy and independent lifestyle have been known. For example, the project “GEWOS—Gesund wohnen mit Stil” (roughly: “living in style in a healthy manner”) (see www.gewos.org) is known which originates from a funding scheme by the German Federal Ministry of Education and Research (Bundesministerium für Bildung and Forschung der Bundesrepublik Deutschland, BMBF). A socio-technical system includes an easy chair comprising sensors and actuators, an internet-based platform, a television set, further interaction elements and matching services. A user is encouraged to make a movement, and the easy chair exhibits strain gages at different positions by means of which various games for mobilization and strengthening may be performed. For example, eight areas of the easy chair may be pressed by muscle power, either in a specific sequence for memory training purposes or as fast as possible for the purpose of training reaction and coordination. Moreover, further sensors may be built in which determine the user's posture and vital signs, for example the weight and the balance, by means of the strain gages, the heart rate by means of two EKG electrodes integrated into the armrests, and oxygen saturation by means of an O₂ sensor. The disadvantage of this approach consists in that the easy chair is elaborately designed and that it is only with difficulty that the various sensors can be integrated into various types of seats. Moreover, the signal quality highly depends on the structure of the seat. There is no processing of the measured data into control signals.

A yet further approach is described by the BMBF's research project akrobatik@home (see www.iis.fraunhofer.de/de/ff/med/proj/sensorik/akrobatik@home.html). Evidence-based training support for encouraging physical activity in physically challenged persons on a daily basis is provided. The system includes a shoulder cushion, which has three sensor nodes of nine-axes inertial sensors integrated therein, and a pressure sensor mat. The data obtained is wirelessly transmitted to a tablet computer, which visualizes a training game. What is disadvantageous about this implementation is the requirement of additional hardware in the form of the shoulder cushion with integrated inertial sensors.

### SUMMARY

According to an embodiment, an apparatus may have: an object for sitting or lying on; a plurality of sensors arranged within the object for sitting or lying on; and a signal processing unit connected to the sensors and configured to generate, on the basis of the sensor signals, an output signal which describes a posture and/or a movement of a person using the an object for sitting or lying on, the generated output signal indicating a center of gravity of the person and/or a physiological process occurring in said person.

According to another embodiment, an apparatus may have: an object for sitting or lying on; a plurality of capacitive proximity sensors or touch sensors arranged within the object for sitting or lying on; and a signal processing unit connected to the sensors and configured to generate, on the basis of the sensor signals, an output signal which describes a pressure distribution and/or a posture and/or a movement of a person using the an object for sitting or lying on.

According to another embodiment, a method may have the steps of: detecting sensor signals from a plurality of sensors arranged within an object for sitting or lying on; and on the basis of the sensor signals, generating an output signal which describes a posture and/or a movement of a person using the object for sitting or lying on, wherein the generated output signal indicates a center of gravity of the person and/or a physiological process occurring in the person.

According to another embodiment, a non-transitory digital storage medium may have a computer program stored thereon to perform the inventive method.

The present invention provides an apparatus comprising an object for sitting or lying on, a plurality of sensors arranged within the object for sitting or lying on, and a signal processing unit connected to the sensors and configured to generate, on the basis of the sensor signals, an output signal which describes a posture and/or a movement of a person using the an object for sitting or lying on, the generated output signal indicating a center of gravity of the person and/or a physiological process occurring in said person.

The inventive approach is advantageous since in the course of a person's seated and/or seated-like states or activities, both simple and complex postures, changes in posture and/or movements may be detected. An output signal, e.g. an electrical signal, is generated which contains, on the basis of the person's posture, change in posture and/or movement, information about a center of gravity, about a physiological process, or about a position and/or a movement of the person. In this manner, a control signal, e.g., for controlling further devices, may be generated in a simple manner according to embodiments.

According to embodiments provision is made for using the control signals to control external devices or to control a drive of the object for sitting or lying on. By shifting the center of gravity due to a movement performed by the person, control may be brought about, for example, either continuously variable control or step-by-step control. According to other embodiments, it is possible to use the physiological signal in addition or as an alternative to determining the center of gravity, for assessing a state that the person who uses the object for sitting or lying on is currently in, e.g. the person's breathing or pulse. Depending on the person's detected state, a suitable action may then be performed. If one of the parameters has reached a threshold value, an alert may be output; for example, when breathing is monitored, a situation of apnea may be detected which is resolved by an acoustic signal waking the person up. Moreover, an emergency may be signaled to a rescue center who will then send help. According to yet other embodiments, a position of the person may additionally or alternatively be monitored. If a position does not change over a relatively long time period, a movement of the object for sitting or lying on may be effected, for example, so as to in turn cause the person to move, so that remaining in the same posture for a relatively long time is avoided.

The present invention further provides an apparatus comprising an object for sitting or lying on, a plurality of capacitive proximity sensors or touch sensors arranged within the object for sitting or lying on, and a signal processing unit connected to the sensors and configured to generate, on the basis of the sensor signals, an output signal which describes a pressure distribution and/or a posture and/or a movement of a person using the an object for sitting or lying on.

### BRIEF DESCRIPTION OF THE DRAWINGS

Embodiments of the present invention will be detailed subsequently referring to the appended drawings, in which:

FIG. 1 shows a schematic representation of an inventive apparatus according to an embodiment;

FIG. 2 shows an embodiment of the inventive apparatus in the form of a seat or an easy chair;

FIG. 3 shows a further embodiment of the inventive apparatus in the form of a bed;

FIG. 4 shows yet another embodiment of the inventive apparatus in the form of a car seat located inside a motor vehicle; and;

FIG. 5 shows different embodiments of the inventive approach, in particular the various possibilities of using the output signal generated by the signal processing unit.

### DETAILED DESCRIPTION OF THE INVENTION

In the following description of the advantageous embodiments, elements which are identical or have identical actions will be provided with identical reference numerals.

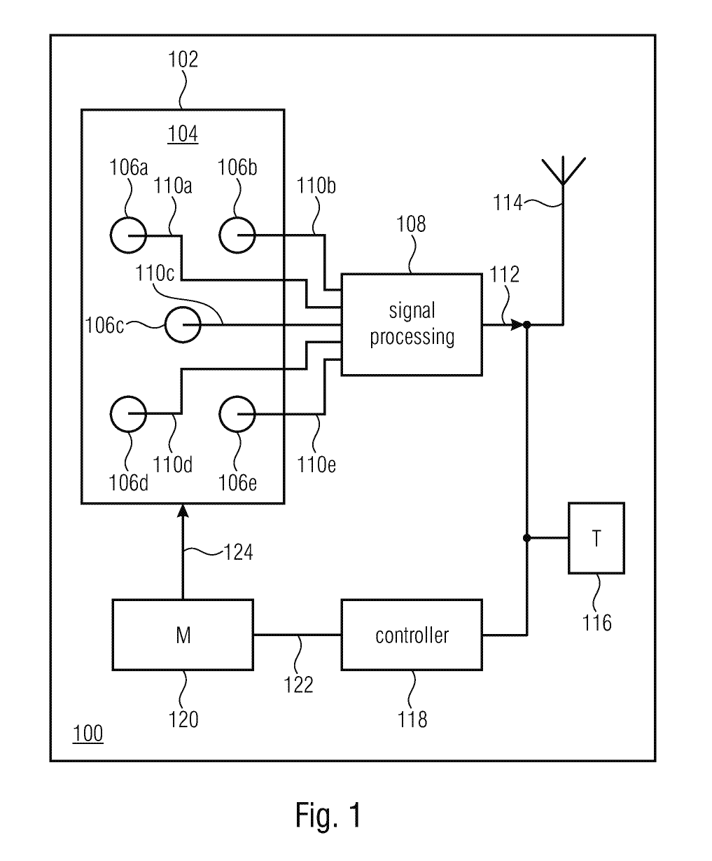

FIG. 1 shows a schematic representation of an inventive apparatus in accordance with an embodiment. The apparatus 100 includes an object for sitting or lying on 102 schematically depicted in FIG. 1. The object 102 may be, e.g., a chair, an easy chair, a couch, a bed or the like. The seat may be, e.g., an easy chair or a seat provided, e.g. within a transport means, for example a car, an airplane or a ship. The object 102 includes a contact surface 104 which in the event of a bed or a couch represents the actual surface to lie on, and in the event of a seat represents the seating surface and/or the backrest (if provided—in case of a simple stool, there is no backrest). A plurality of sensors 106a-106e have been mounted into the contact surface 104, for example pressure sensors or movement sensors. The sensors may include capacitive, inductive and/or resistive sensors. Advantageously, capacitive proximity sensors or proximity and/or touch sensors such as are used in touchscreens of smartphones, for example, are employed rather than using conventional pressure sensors or conventional inertial measurement units (IMU). An advantage of capacitive proximity sensors or of touch sensors is the fact that they can be easily integrated in textile materials, e.g. that a capacitive proximity sensor or touch sensor can be easily integrated into a textile material which is used as a cover for a seating and/or lying surface or which surrounds a mattress. The apparatus 100 further includes a signal processing unit 108 connected to the sensors 106a-106e via interconnection lines 110a-110e. Via the lines 110a-110e, the signal processing unit 108 receives the sensor signals from the sensors 106a-106e at corresponding inputs, which are not explicitly depicted in FIG. 1. The signal processing unit may be, e.g., a microcontroller, a computer or any other data processing unit which is programmed accordingly to generate an output signal on the basis of the signals received. On the basis of the values of the sensor signals, an output signal 112 is generated which indicates the posture and/or a movement of a person using the object 102, said output signal indicating a center of gravity of the person positioned on the object 102 and/or a physiological process occurring in said person. The physiological process may indicate vital signs of the person or a specific physiological event. Ergonomic evaluation may be performed on the basis of the person's position and/or movement.

According to embodiments, the signal processing unit 108 is configured such that instantaneous load distribution is determined on the basis of the values of the sensor signals of the pressure sensors. In other embodiments employing touch sensors, a determination is performed, on the basis of the values of the sensor signals of the touch sensors, in terms of which parts of the seating and/or lying surface are occupied by the person. On the basis of said sensor signals, an instantaneous center of gravity of the person will then be determined. According to further embodiments, this may be performed by means of vectorial interpretation of the sensor signals with regard to their measuring position or by means of a neuronal network by using learned data sets. In yet other embodiments, it is also possible to infer the body's silhouette and, thus, the seating contact surface (static case) and/or movements (dynamic case) of the person from the sensor signals.

According to embodiments, the apparatus 100 further includes an antenna 114, a terminal 116 and/or an internal controller 118. According to embodiments, individual or all of the above-mentioned elements, namely the antenna 114, the terminal 116 and the controller 118, are provided. The antenna 114 serves to wirelessly communicate the output signal 112 to external units. The terminal 116 serves for connection with a plug for transmitting the output signal 112 to further elements or external units via a wired connection. The internal controller 118 is connected to a motor 120. The controller 118 generates the control signals 122 for the motor 120 independently of the output signal 112, which motor 120, for its part, changes positions of parts of the object for sitting or lying on 102, as is schematically indicated by the arrow 124.

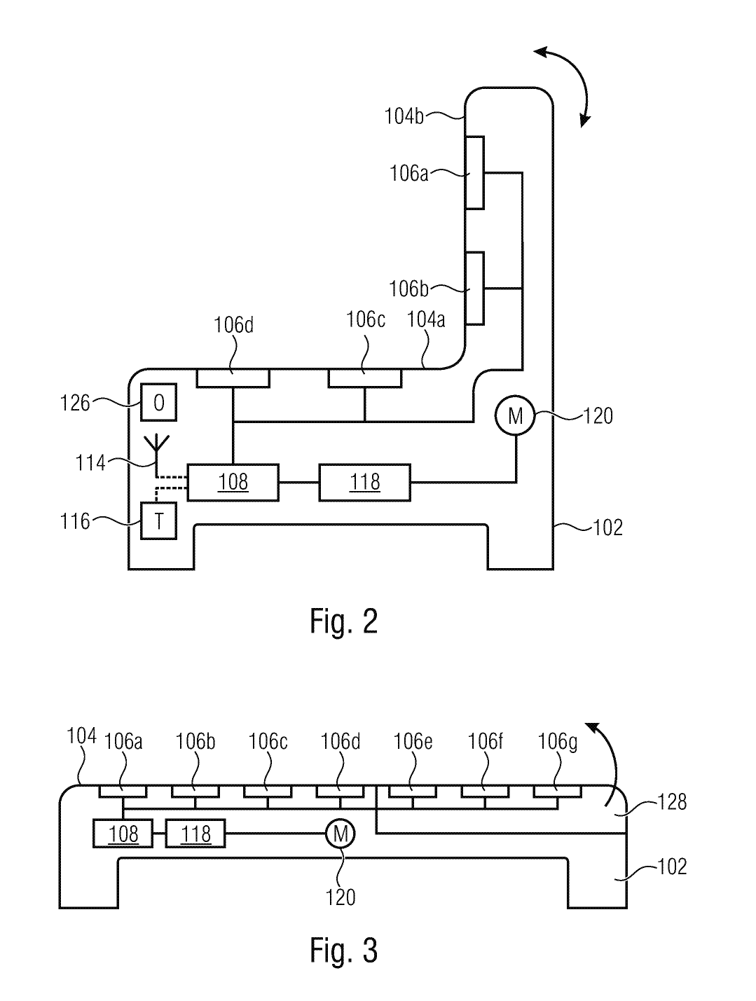

FIG. 2 shows an embodiment of the inventive apparatus in the form of a seat or an easy chair 102. In FIG. 2, the elements that were already described with reference to FIG. 1 are provided with the same reference numerals and will not be described once again. The seat 102 includes four sensors 106a-106d, but different arrangement patterns may also have more or fewer sensors arranged therein. The seat 102 includes the contact surface 104 in the form of the seating surface 104a and in the form of the rest 104b, the sensors being arranged both within the seating surface and within the rest. In other embodiments, it is possible for an array of sensors to be arranged only within the rest or only within the seating surface. Moreover, the antenna 114 and the terminal 116 are depicted, which are optional elements, as is indicated by the dotted connection to the control unit 108. The motor 120 is provided to tilt the rest as a function of a control signal, for example. In other embodiments, the motor 120 is provided to drive other parts of the seat 102, for example so as to move different sections of the seating surface 104a and/or of the rest 104b. The seat 102 may comprise an additional operator control panel 126 arranged, for example, in the front area of the seat 102. The additional operator control panel 126 enables the person using the seat 102 to effect a direct input by touching buttons of the operator control panel 126 or of a user interface of the operator control panel 126, for example so as to control the motor 120 to adjust different parts of the seat 102. In addition, in the embodiment shown in FIG. 2, the sensors 106a-106d may be provided to detect physiological information directly from the person sitting in the seat 102, for example via respiration or pulse. Possibly, further sensors are provided, e.g. in the form of an EKG sensor or an oxygen sensor. Moreover, the control system may be connected to a further control unit, e.g. a game pad, so as to enable actuation of additional buttons.

FIG. 3 shows a further embodiment of the inventive apparatus in the form of a bed 102. In FIG. 3, too, the elements that were already described with reference to FIG. 1 are provided with the same reference numerals and will not be described once again. The contact surface 104 of the bed 102 is its lying surface, which comprises seven sensors 106a-106g. Moreover, a movable headboard 128 is depicted which, as is indicated by the arrow, is configured to be adjustable in height by the motor 120, for example as a function of control signals of the controller 118.

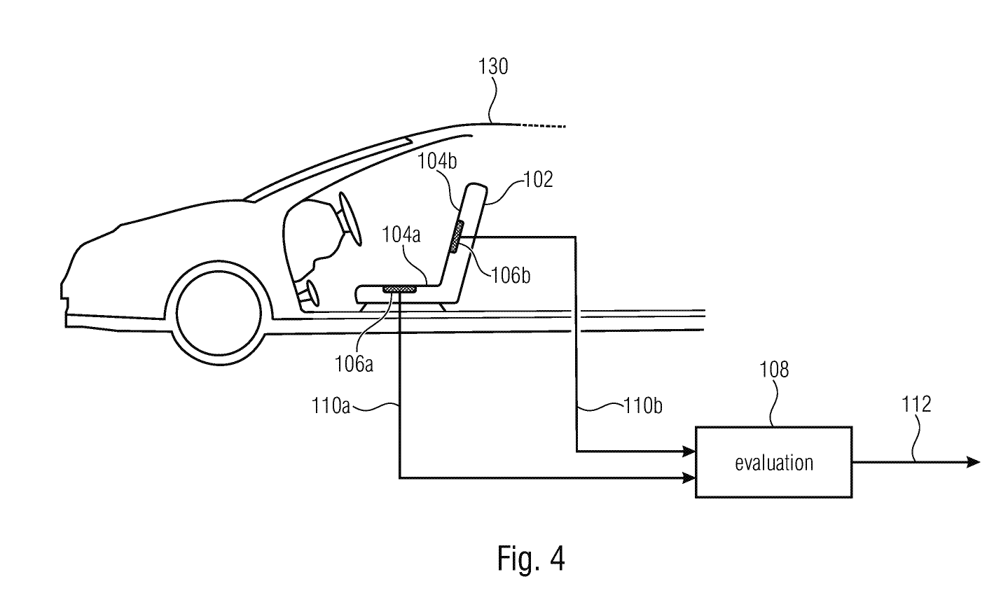

FIG. 4 shows yet another embodiment of the inventive apparatus in the form of a car seat arranged inside a motor vehicle 130, e.g. a motor vehicle with internal combustion or a motor vehicle with an electric powertrain. In the embodiment shown in FIG. 4, the signal processing unit 108 does not form part of the seat 102 but is part of the motor vehicle's electronic system, for example a central control unit of the motor vehicle 130. Two sensors 106a, 106b are schematically shown which are arranged within the seating surface 104a and/or within the rest 104b of the seat 102 and are connected to the signal processing unit 108 located within the motor vehicle's electronic system via the lines 110a, 110b.

As was mentioned above, the inventive approach serves to detect, on the basis of the sensor signals, a posture/movement of a person using the object for sitting or lying on so as to obtain therefrom a center of gravity and/or a change in the center of gravity, a position and/or a physiological signal relating to the person which will then be output by the signal processing unit in the form of the output signal 112.

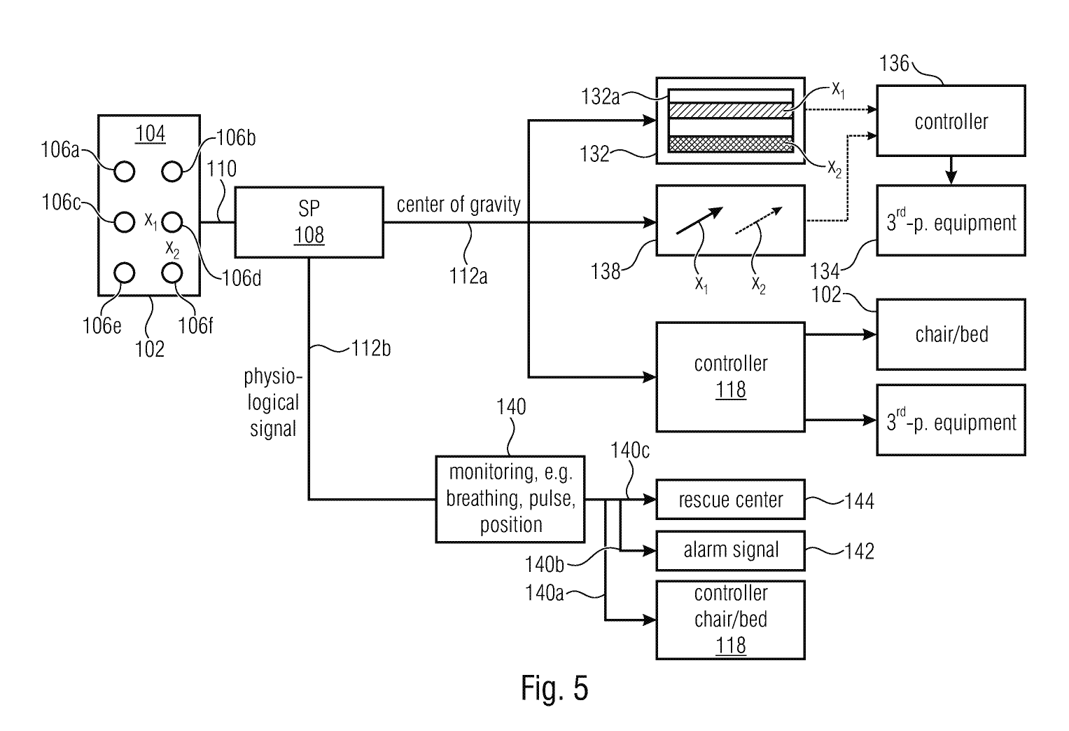

FIG. 5 schematically shows various embodiments of the inventive approach, in particular the various possibilities of using the output signal generated by the signal processing unit 108. FIG. 5 schematically shows the object for sitting/lying on 102, including the sensors 106a to 106f arranged within the contact surface 104 and connected to the signal processing unit 108 via the lines 110. The signal processing unit 108 generates, as the output signal 112, a signal 112a indicating the center of gravity and/or a physiological signal 112b relating to the person using the seat.

According to embodiments, the center-of-gravity signal 112a is used as a control signal for various applications. In a first embodiment, the center-of-gravity signal 112a is supplied to a device 132, which is a television set or any other multimedia device comprising a display 132a, for example. According to embodiments, the further device 132 may also be arranged within a vehicle, e.g. a car or a motorcycle, an airplane or a ship. According to further embodiments, the further device 132 may include a PC mouse, a pair of VR glasses or a joystick. The display 132a presents various entries which may be selected as a function of the center of gravity. FIG. 5 depicts a first center of gravity x1 selecting a first entry x1 in the display 132a. If the person in the seat 102 is moving, the center of gravity will move to the position x2, so that a different entry x2 on the display 132a will be highlighted and/or selected. The controller may generate a continuous control signal, so that a shift in the center of gravity results in a corresponding change in the selected entry. In other embodiments, a shift in the center of gravity beyond a specific threshold may generate a control signal, so that the system switches from a currently selected entry x1 to a next entry x2, which may then be highlighted. When the person moves several times in relation to the original center of gravity or the new center of gravity, this will cause the entries to be switched through. Moreover, in addition to threshold value determination, it is also possible to detect a direction of the shift in the center of gravity so as to cause a corresponding upward or downward movement in a table or, if the table also comprises several columns, a movement to the left or to the right. According to embodiments, scrolling through a document or through a map may also be caused by a shift in the center of gravity.

The approach described may be used, e.g., in TV sets, for changing programs, setting the volume or changing other menu settings. In other embodiments, the device 132 may be part of a display device of a different device, or third-party equipment, 134. The equipment 134 is connected to the display 132 via a controller 136, so that a setting of the third-party equipment 134 is changed as a function of a menu point selected via the display 132a. For example, the means 132 may be a computer which is connected to various household appliances 134, for example radio equipment, an air-conditioning unit, a household appliance or the like, via the controller 136.

According to a further embodiment, the control signal 112a may be employed in a Windows-based environment, as is schematically depicted by the display 138. The display 138 is a computer monitor or the display of a mobile terminal device, for example. By shifting the center of gravity, a display element, for example a cursor arrow, is moved. The display 138 may be part of a computer system, so that the computer may be controlled accordingly. As was described above, via the corresponding controller 136 it is alternatively also possible to control, via the computer and/or the display, third-party equipment 134 connected thereto. According to embodiments, a game controller for PCs, consoles, an auto media system, small (mobile) appliances and the like are provided, in particular.

Yet another implementation relates to the generation of control signals by the above-described controller 118, so that depending on a shift in the center of gravity, different parts of the seat or of the bed 102, for example parts of the seating/lying surface or of the rest, may be adjusted in line with the shift in the center of gravity. Additionally or alternatively, it is also possible to directly control the above-mentioned third-party equipment via the controller 118, again via a corresponding shift in the center of gravity. The above-mentioned third-party equipment may be multimedia equipment, telephone terminals or game consoles, for example.

According to further embodiments, the signal processing unit 108 generates the physiological signal 112b. For example, on the basis of continuously captured sensor signals, a position of the person on the contact surface 104 is detected and/or one or more characteristic, numerical parameters of a physiological process are generated. According to further embodiments, a movement pattern may additionally or alternatively be detected and analyzed to enable ergonomic evaluation. The signal 112b may be supplied to a monitoring unit 140, which is either part of the inventive apparatus or is arranged at a distance from the inventive apparatus, for example at a central location inside a house or at a rescue center. The signal 112b may be transmitted to the monitoring unit 140, e.g., via a radio connection by means of the above-mentioned antenna 114 or via a wired connection, e.g. via the public fixed network, via the terminal 116. The monitoring unit may monitor the position, indicated via the signal 112a, of the person on the contact surface so as to output a signal 140a to the controller 118 if a certain amount of time has passed without any change in position taking place, so as to cause individual or several parts of the object for sitting or lying on 102 to be adjusted. Alternatively, a trigger signal 140b may be generated so as to output an alarm signal or an warning signal to the user of the means 102 via an alarm generator 142.

If the output signal 112 includes a physiological signal, it may be a respiration signal, a pulse signal or a ballistocardiogram. The signal processing unit 108 generates an output signal 112a indicating a respiratory rate, a pulse rate, an inspiration time, an expiration time and/or a relative depth of breathing, said signal being monitored by the monitoring unit 140. Depending on the values received, for example when a specific threshold of a parameter is reached, the monitoring unit 140 may generate the signal 140b for the alarm generator 142. For example in the event of sleep apnea, an acoustic signal may be output in order to wake up the user and thus to interrupt the state of apnea. Alternatively, provision may be made for generating an alarm signal 140c and to forward same to a rescue center 144, so that corresponding rescue workers may be alerted by the rescue center to go to the person's rescue. According to embodiments, the detected physiological information may be embedded into the signal forwarded to the rescue center (eCall alert), so that in addition to the actual signal, there are already information provided about the emergency and the state of the patient at the point of alerting, so that one may react accordingly and/or so that the rescue team may make corresponding preparations.

According to the invention, an approach is thus taught wherein a change in the signals measured by the sensors, which change is caused by the posture and/or movement of the user, is evaluated. By means of various signal processing techniques, the instantaneous center of gravity is determined from the instantaneous load distribution so as to be used as a continuously variable control signal, by analogy with a joystick of a game pad, or as a binary control signal as a function of one or more threshold values, by analogy with a D-Pad, e.g. of a computer keyboard.

The control signals thus obtained may be used, e.g., for multimedia or game control purposes, and may be transmitted to a terminal device, e.g. a specific multimedia system, a computer and/or any other feedback system, in a wireless manner—e.g. by means of Bluetooth Low Energy (BLE)—or in a wired, or tethered, manner.

The inventive approach has several advantages, some of which include the following:
simple integration into various seat structures/bed designs by positioning the sensor technology between the seat cover and the seat padding,
a solution which is highly comfortable in that it uses flexible or textile sensors,
the visual effect of the seat is not affected by integrating the system,
hand-free controlling of events,
determining the user's movement/position without any optical measurement system, whereby application in small rooms becomes possible, and
encouragement to move.

Embodiments of the invention thus provide an approach to detecting simple and complex postures and/or movements as well as changes in the posture and/or movement by means of an object to sit on or an object to lie on for describing interpreting modalities of posture and/or movement and/or for controlling events by means of sensor technologies. Embodiments of the invention have been employed in the following technical fields of application, for example:
playing computer games while being seated (e.g. car seat or airplane seat or easy chair in a living room),
performing control by using the seat (e.g. menu guidance of television sets or car multimedia),
motivation to move
relaxation by means of movement exercises in suitable situations (e.g. traffic jam),
increase in vitality due to movement,
training support to encourage daily physical activity (e.g. adipose children, physically impaired people, elderly people living in an AAL environment),
boosting the cardiovascular system,
ergonomic evaluations,
strengthening the muscles of the back,
prevention of muscular-skeletal diseases,
training a person's cognitive capacities (e.g. by memory games etc.),
enabling control of various events for physically impaired persons (e.g. PC mouse control for thalidomide victims),
eCall emergency call system,
application as a human machine interface.

So far, embodiments have been described wherein the output signal generated by the inventive apparatus indicates a center of gravity of the person and/or a physiological process occurring in the person. The present invention is not limited thereto. According to other embodiments, an apparatus is provided which includes an object for sitting or lying on and a plurality of capacities proximity sensors or touch sensors arranged within the object for sitting or lying on. In this embodiment, provision is made for the signal processing unit connected to the sensors to generate, on the basis of the sensor signals, an output signal describing a pressure distribution and/or a posture and/or a movement of a person using the object for sitting or lying on. According to further embodiments, provision may further be made for the further information to be obtained and used on the basis of this output signal, as was described above.

Even though some aspects have been described within the context of an apparatus, it is understood that said aspects also represent a description of the corresponding method, so that a block or a structural component of an apparatus is also to be understood as a corresponding method step or as a feature of a method step. By analogy therewith, aspects that have been described in connection with or as a method step also represent a description of a corresponding block or detail or feature of a corresponding apparatus.

Depending on specific implementation requirements, embodiments of the invention may be implemented in hardware or in software. Implementation may be effected while using a digital storage medium, for example a floppy disc, a DVD, a Blu-ray disc, a CD, a ROM, a PROM, an EPROM, an EEPROM or a FLASH memory, a hard disc or any other magnetic or optical memory which has electronically readable control signals stored thereon which may cooperate, or actually do cooperate, with a programmable computer system such that the respective method is performed. This is why the digital storage medium may be computer-readable. Some embodiments in accordance with the invention thus comprise a data carrier which comprises electronically readable control signals that are capable of cooperating with a programmable computer system such that any of the methods described herein is performed.

Generally, embodiments of the present invention may be implemented as a computer program product having a program code, the program code being effective to perform any of the methods when the computer program product runs on a computer. The program code may also be stored on a machine-readable carrier, for example.

Other embodiments include the computer program for performing any of the methods described herein, said computer program being stored on a machine-readable carrier.

In other words, an embodiment of the inventive method thus is a computer program which has a program code for performing any of the methods described herein, when the computer program runs on a computer or a microcontroller. A further embodiment of the inventive methods thus is a data carrier (or a digital storage medium or a computer-readable medium) on which the computer program for performing any of the methods described herein is recorded.

A further embodiment of the inventive method thus is a data stream or a sequence of signals representing the computer program for performing any of the methods described herein. The data stream or the sequence of signals may be configured, for example, to be transferred via a data communication link, for example via the internet.

A further embodiment includes a processing means, for example a computer or a programmable logic device, configured or adapted to perform any of the methods described herein.

A further embodiment includes a computer on which the computer program for performing any of the methods described herein is installed.

In some embodiments, a programmable logic device (for example a field-programmable gate array, an FPGA) may be used for performing some or all of the functionalities of the methods described herein. In some embodiments, a field-programmable gate array may cooperate with a microprocessor to perform any of the methods described herein. Generally, the methods are performed, in some embodiments, by any hardware device. Said hardware device may be any universally applicable hardware such as a computer processor (CPU), or may be a hardware specific to the method, such as an ASIC.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fall within the true spirit and scope of the present invention.

1. An apparatus comprising
an object for sitting or lying on;
a plurality of sensors arranged within the object for sitting or lying on; and
a signal processing unit connected to the sensors and configured to generate, on the basis of the sensor signals, an output signal which describes a posture and/or a movement of a person using the an object for sitting or lying on,
the generated output signal indicating a center of gravity of the person and/or a physiological process occurring in said person.

2. The apparatus as claimed in claim 1, wherein the signal processing unit is configured to determine an instantaneous load distribution on the basis of the values of the sensor signals and to determine an instantaneous center of gravity of the person on the basis of the determined instantaneous load distribution.

3. The apparatus as claimed in claim 2, wherein the signal processing unit is configured to determine the instantaneous center of gravity by means of a vectorial interpretation of the sensor signals with regard to their measurement locations or by means of a neuronal network by using learned data sets.

4. The apparatus as claimed in claim 1, wherein the signal processing unit is configured to provide, when the person is moving, a continuous control signal on the basis of the change in the center of gravity.

5. The apparatus as claimed in claim 1, wherein the signal processing unit is configured to provide, when the person is moving, a control signal if the change in the center of gravity reaches a threshold value.

6. The apparatus as claimed in claim 4, comprising:
a drive configured to adjust positions of different parts of the object for sitting or lying on; and
a controller connected to the drive and configured to control the drive on the basis of the control signal so as to effect adjustment of the positions of the different parts of the object for sitting or lying on.

7. The apparatus as claimed in claim 4, wherein the control signal serves to control an external unit.

8. The apparatus as claimed in claim 7, wherein the external unit comprises an input device for a computer, a computer and/or one or more items of third-party equipment.

9. The apparatus as claimed in claim 8, wherein the third-party equipment comprises a multimedia device or a gaming device.

10. The apparatus as claimed in claim 1, wherein the signal processing unit is configured to continuously detect the sensor signals and to determine the following from the continuously detected sensor signals:
a position of the person, and/or
one or more characteristic, numerical parameters of the person's physiological process, and/or
movement patterns for ergonomic evaluation.

11. The apparatus as claimed in claim 10, wherein the signal processing unit is configured to determine a respiratory curve, a pulse curve or a ballistocardiogram from the continuously detected sensor signals, the characteristic, numerical parameter comprising a respiratory rate, a pulse rate, an inspiration time, an expiration time and/or a relative depth of breathing.

12. The apparatus as claimed in claim 10, wherein information about the person's position and/or the characteristic, numerical parameter of a monitoring unit is provided, the monitoring unit being configured to signal when a change in position is advisable and/or when the characteristic, numerical parameter reaches a threshold value.

13. The apparatus as claimed in claim 12, wherein the monitoring unit is configured to make an emergency call to a rescue center, it being possible for the emergency call to also comprise information about the physiological process.

14. The apparatus as claimed in claim 12, wherein the monitoring unit is part of the apparatus or wherein the monitoring unit is arranged at a distance from the apparatus.

15. The apparatus as claimed in claim 1, comprising wireless or wired communication unit, the signal processing unit being configured to cause transmission of the output signal.

16. The apparatus as claimed in claim 1, wherein the object for sitting or lying on comprises a contact surface, and wherein the sensors comprise a plurality of pressure sensors and/or touch sensors arranged in the contact surface in a distributed manner.

17. The apparatus as claimed in claim 16, wherein the sensors comprise capacitive proximity sensors or touch sensors.

18. The apparatus as claimed in claim 1, comprising a controller and/or an operator control panel for controlling the object for sitting or lying on by means of a direct input into the controller and/or the operator control panel.

19. The apparatus as claimed in claim 1, comprising further sensors for detecting physiological information of the person.

20. An apparatus comprising
an object for sitting or lying on;
a plurality of capacitive proximity sensors or touch sensors arranged within the object for sitting or lying on; and
a signal processing unit connected to the sensors and configured to generate, on the basis of the sensor signals, an output signal which describes a pressure distribution and/or a posture and/or a movement of a person using the an object for sitting or lying on.

21. A method comprising:
detecting sensor signals from a plurality of sensors arranged within an object for sitting or lying on; and
on the basis of the sensor signals, generating an output signal which describes a posture and/or a movement of a person using the object for sitting or lying on,
wherein the generated output signal indicates a center of gravity of the person and/or a physiological process occurring in the person.

22. A non-transitory digital storage medium having a computer program stored thereon to perform the method comprising:
detecting sensor signals from a plurality of sensors arranged within an object for sitting or lying on; and
on the basis of the sensor signals, generating an output signal which describes a posture and/or a movement of a person using the object for sitting or lying on,
wherein the generated output signal indicates a center of gravity of the person and/or a physiological process occurring in the person,
when said computer program is run by a computer.
